(19) United States
(12) Patent Application Publication
(10) Pub. No.: US 2010/0239829 A1
(43) Pub. Date: Sep. 23, 2010

(54) Method for Manufacturing Bamboo Decorative Sheet and Bamboo Decorative Sheet thereof

(76) Inventor: Ying-Sung Chou, Taiwan (CN)

Correspondence Address: Portal IPR Services, P.O. Box 223205, Chantilly, VA, 20153, US

(21) Appl. No.: 12/443,479

(22) PCT Filed: Oct. 23, 2006
(86) PCT No.: PCT/CN06/02821

§ 371 Date: Mar. 29, 2009

(51) Int. Cl. B32B 38/04; B32B 3/10

(52) U.S. Cl. 428/195.1; 156/256; 156/254; 156/266

(57) ABSTRACT

In a method for manufacturing a bamboo decorative sheet and a bamboo decorative sheet thereof, the method is applicable to a large volume bamboo board formed by gluing and stacking bamboo chips made of bamboo tube materials. The method includes the step as follows. The large volume bamboo board is provided. The bamboo board is beveled to form an upper and a lower part, and the two parts are reversed. Then the two parts are overlapped and glued to form a composite bamboo board. The composite bamboo board is sliced into film-like bamboo decorative sheets, so that the bamboo decorative sheet with a surface having decorative grain is formed. The method has developed the invariable straight strip-like decorative grain in the prior art into the lattice or diagonal grains, and the size of the lattice or diagonal grains can be adjusted, such that the bamboo decorative sheet with a variety of grain can be produced to meet the customers' requirements.

### CROSS REFERENCE TO RELATED APPLICATIONS

This application claims the benefit of PCT application Serial No. PCT/CN2006/002821 filed on Oct. 23, 2006, the entire disclosure of which is incorporated herein by reference.

### BACKGROUND OF THE INVENTION

1. Field of Invention

The present invention relates to a method for manufacturing a bamboo decorative sheet and a manufactured article thereof, in particular, to a method for manufacturing a bamboo decorative sheet with lattice grain or diagonal grain and a manufactured article thereof.

2. Related Art

Generally, purposes of the bamboo are limited to the fabrication of simple furniture, temporary building materials, common ornaments, and cheap craftworks etc. If the bamboo is used to fabricate floor boards, wainscots, or veneering of furniture with high values, the manual assembly is much labor-consuming and time-consuming, and thick glue lines makes the products assume a low quality. Therefore, the industrial production cannot be performed. Further, the bamboo has extremely large inner stress, and is quite easily de-glued and broken because of moisture absorption, expansion, and deformation under inappropriate processing.

Because of the above disadvantages, the application of the bamboo to the fields of decoration and furniture ornament cannot be developed, and until Taiwan, R.O.C. patent publication No. 393389 is proposed, the mass production may be effectively achieved. In the patent specification, during the manufacturing process, appropriate bamboo tube raw materials are selected, and are cut into bamboo strips with a small arc diameter section. Then, a high moisture content process is performed. The bamboo strips are cut into bamboo chips with square section in a preset small unit. A larger unit of bamboo chip is formed by pressing and stacking the bamboo chips of small unit by using a room temperature cured, water-proof, and heat-resistant adhesive. A bamboo board with a large volume is formed by pressing and stacking most of the larger unit bamboo chips by using the adhesive. The large volume bamboo board is cut by a slicer to sheets (films). Thus the bamboo decorative sheets (films) with a large area are shaped.

However, the high moisture content process is performed on raw bamboo manufactured articles with the insufficient moisture content. If the high moisture content of the bamboo tube material may be maintained, it is not necessary to perform the high moisture content process.

However, as shown in FIG. 1, for the bamboo decorative sheet 10 or the sheet formed by using the manufacturing method, the grain are only the straight strip shaped grain 11 and the raw bamboo grain 12, such that it is slightly insufficient for the customer selection.

### SUMMARY OF THE INVENTION

Accordingly, the present invention is directed to a method for manufacturing a bamboo decorative sheet, capable of naturally forming the bamboo decorative sheet with lattice grain or diagonal grain besides the straight strip-like grain during the manufacturing process. The present invention is further directed to provide a bamboo decorative sheet with jointed lattice grain or diagonal grain.

As embodied and broadly described herein, the present invention provides a method for manufacturing a bamboo decorative sheet, which is applicable to a large volume bamboo board formed by gluing and stacking bamboo chips made of bamboo tube materials. The method for manufacturing a bamboo decorative sheet with lattice grain includes the step as follows:

providing the large volume bamboo board;

bevel cutting the large volume bamboo board to form an upper part and a lower part, reversing the upper part and the lower part, overlapping and gluing the two parts to a composite bamboo board; and

Slicing the composite bamboo board into a plurality of film-like bamboo decorative sheets, so that a bamboo decorative sheet with a surface having decorative grain is formed.

Slicing surfaces in the step of slicing the composite bamboo board are parallel to a plane of the composite bamboo board, and the decorative grain on the surface of the bamboo decorative sheet is a lattice grain.

Slicing surfaces in the step of slicing the composite bamboo board are parallel to a lateral side of the composite bamboo board, and the decorative grain on the surface of the bamboo decorative sheet is a diagonal grain.

After the step of slicing the composite bamboo board into the plurality of film-like bamboo decorative sheets, the method further comprises jointing the film-like bamboo decorative sheets to form a bamboo decorative sheet with a larger area.

An absolute dry moisture content of the material of the large volume bamboo board is smaller than 20%, the bamboo board is sliced into the bamboo decorative sheets in parallel by sawing, a thickness of the sawed bamboo decorative sheet is between 1.5 mm and 5.0 mm, and a glue used in the gluing step is a water-proof glue comprising urea adhesive, melamine adhesive, phenol adhesive, polyvinyl acetate adhesive, resorcinol resin adhesive, or modified adhesives thereof.

The bamboo decorative sheet manufactured by the method has lattice grain or diagonal grain.

The method further comprises performing a process of maintaining a high moisture content of the raw bamboo material or performing the high moisture content process on the bamboo tube materials, the bamboo chips, and the large volume bamboo boards, such that an absolute dry moisture content is larger than 25%, and the bamboo board is sliced into the bamboo decorative sheets, a thickness of the sliced bamboo decorative sheet is between 0.1 mm and 2.0 mm, and an adhesive used in the gluing step is an polyurethane adhesive or an water-proof polyvinyl acetate adhesive.

The bamboo decorative sheet manufactured by the method has lattice grain or diagonal grain.

The present invention has developed the invariable straight strip-like decorative grain in the prior art into the lattice grain or diagonal grain, and the size of the lattice grain or diagonal grain can also be adjusted, such that the bamboo decorative sheet with a variety of grain can be produced and various requirements of the customers can be achieved.

### BRIEF DESCRIPTION OF THE DRAWINGS

FIG. 1 is an outside view of a bamboo decorative sheet with strip grain in the prior art;

FIGS. 2A to 2C are schematic three-dimensional views of forming a composite bamboo board by laterally bevel cutting a bamboo board to form an upper part and a lower part, reversing the upper part and the lower part, and overlapping and gluing the two parts according to the present invention;

FIGS. 2D to 2G are schematic views of planar slicing the composite bamboo board into a plurality of bamboo sheets or bamboo flat plates according to the present invention;

FIG. 3 is a schematic partial enlarged view of a view A of FIG. 2G according to the present invention;

FIG. 4 is a schematic view of lateral slicing the composite bamboo board to the plurality of bamboo sheets or bamboo flat plates according to the present invention;

FIGS. 5A to 5D are schematic views of jointing the bamboo sheets or the bamboo flat plates with diagonal grain to the bamboo decorative sheet with a larger area according to the present invention;

FIG. 6A is a schematic three-dimensional view of a bamboo tube material according to the present invention;

FIG. 6B is a schematic three-dimensional view of a bamboo strip with an arc diameter section according to the present invention;

FIG. 6C is a schematic three-dimensional view of a strip-like bamboo chip with a square section according to the present invention;

FIG. 6D is a schematic three-dimensional view of a plate unit formed by gluing and stacking according to the present invention; and

FIG. 6E is a schematic three-dimensional view of a bamboo board with a large volume formed by gluing and stacking according to the present invention.

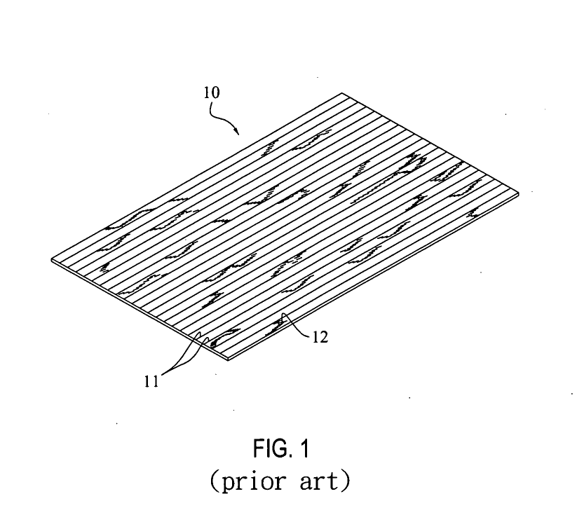

### DETAILED DESCRIPTION OF THE INVENTION

A detailed description of the present invention is given as follows with accompanying drawings and embodiments of the present invention.

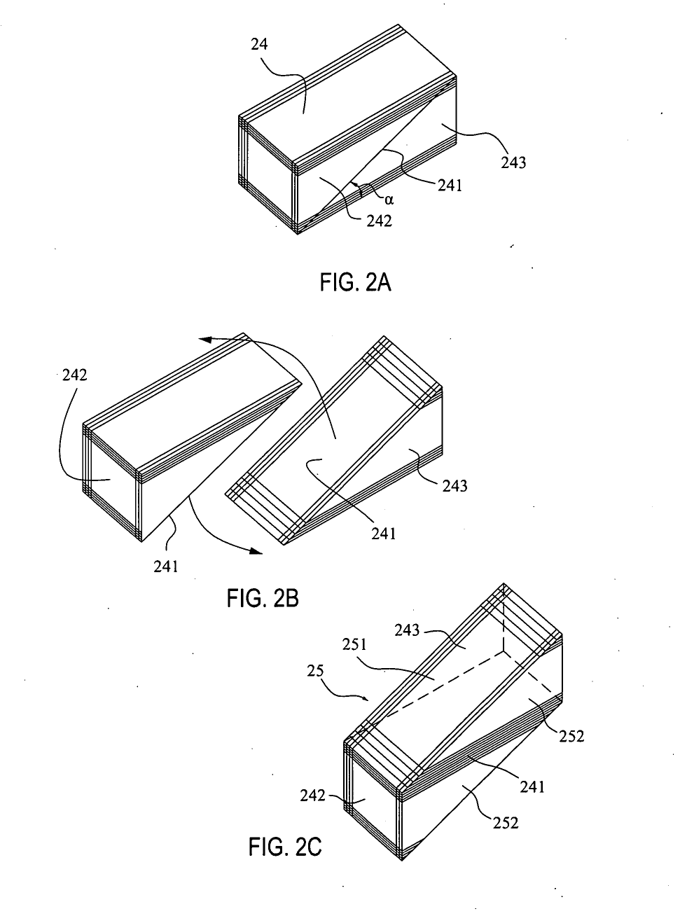

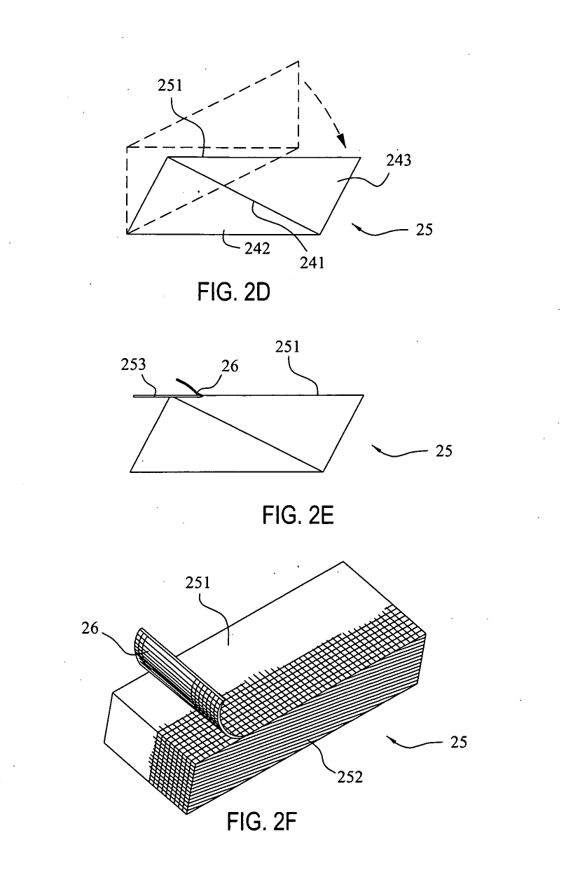

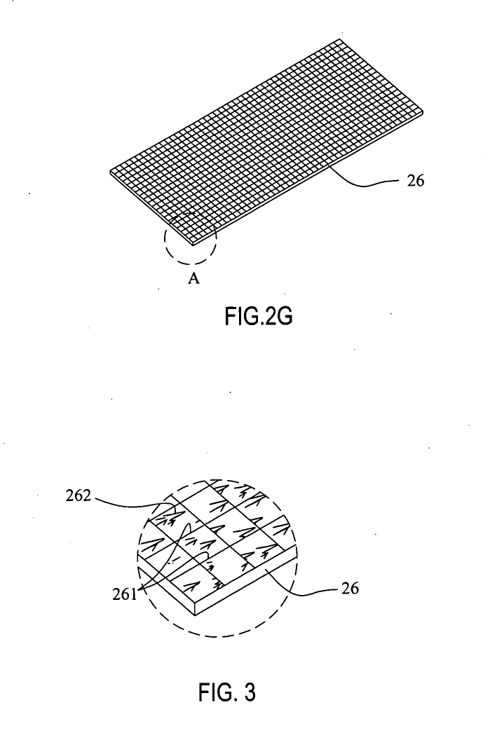

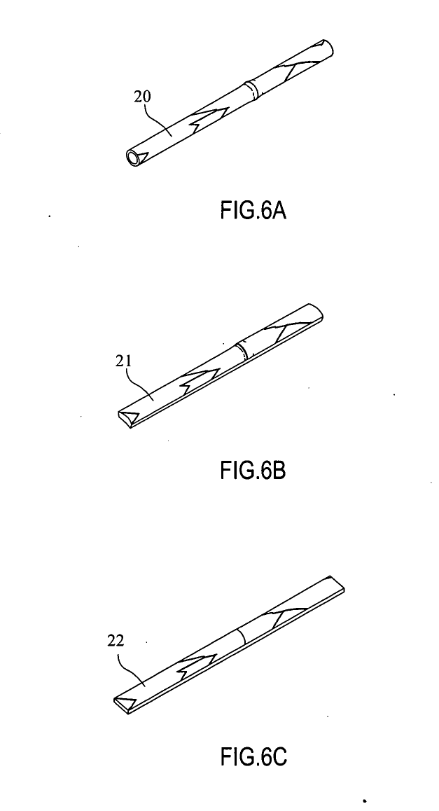

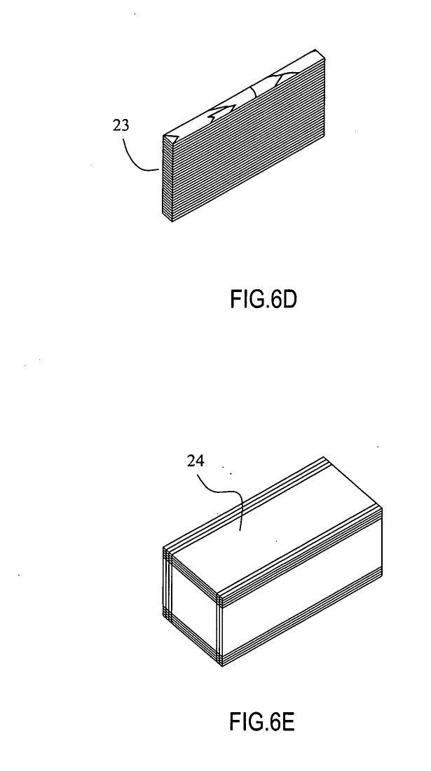

Referring to FIGS. 2A to 2C, FIGS. 2D to 2G, and FIG. 3 which is a schematic partial enlarged view of a view A of FIG. 2G, schematic structural views of each flow of a method for manufacturing a bamboo decorative sheet with lattice grain are shown. The method includes the steps as follows. Firstly, a large volume bamboo board 24 is provided. A plurality of bamboo tube materials 20 is radially cut to a plurality of bamboo strips 21 with an arc diameter section, the bamboo strip 21 is cut to a plurality of bamboo chips 22 with a square section, then the bamboo chips 22 are glued and stacked to form a plurality of plate units 23, next the plate units 23 are glued and stacked to form the large volume bamboo board 24 (referring to FIGS. 6A to 6E).

Next, the large volume bamboo board 24 is beveled, so as to form a beveling surface 241 and divide the bamboo board into an upper part 242 and a lower part 243. Then, the upper part 242 and the lower part 243 are reversed, overlapped, and glued to form a composite bamboo board 25.

Finally, the composite bamboo board 25 is sliced into a plurality of film-like bamboo decorative sheets 26. Slicing surfaces are parallel to a plane 251 of the composite bamboo board, so as to form the bamboo decorative sheets 26 with surfaces having lattice grain, in which the lattice 261 has raw bamboo grain 262.

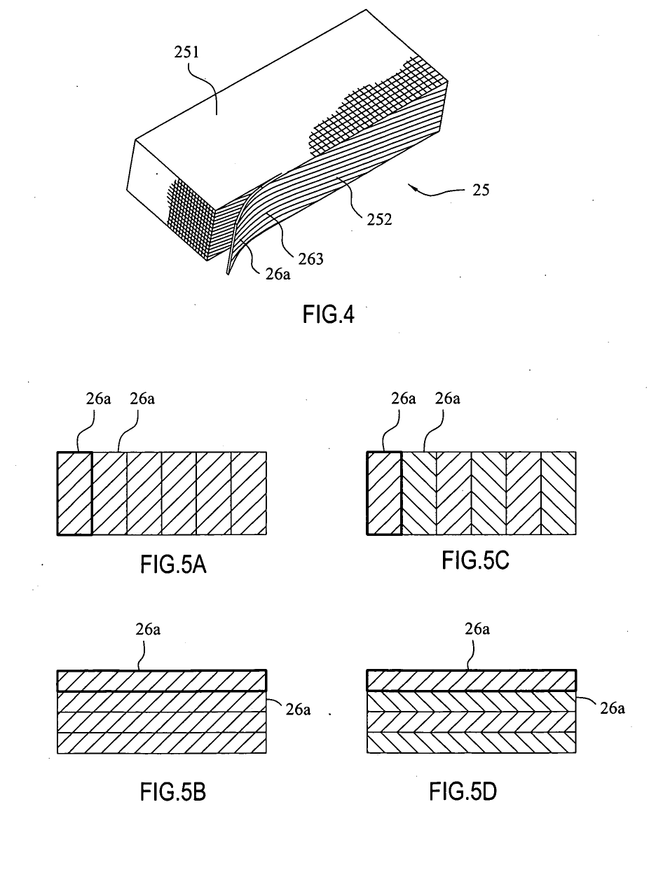

In addition, referring to FIG. 4, it is a schematic view of lateral slicing the composite bamboo board into the plurality of bamboo sheets or bamboo flat plates according to the present invention. The composite bamboo board 25 may be sliced parallel to the plane 251 of the composite bamboo board 25, and in addition, the slicing surfaces may be parallel to a lateral side 252 of the composite bamboo board, so as to form a plurality of film-like bamboo decorative sheets 26a with surfaces having diagonal grain 263.

During the manufacturing process, the high moisture content process is not performed on the bamboo in each step, and a drying process is performed, such that an absolute dry moisture content of the bamboo is smaller than 20%, which is a so-called dry method. Therefore, during the process of slicing the composite bamboo board 25 in the dry method, the composite bamboo board 25 is sawed by a cutting tool 253 of a saw machine to the bamboo decorative sheets 26 or the bamboo flat plates with the lattice grain or the diagonal grain, and a thickness of the bamboo flat plate is between 1.5 mm and 5.0 mm.

When the dry method is used, an adhesive used in the gluing step is a water-proof adhesive, including urea adhesive, melamine adhesive, phenol adhesive, polyvinyl acetate adhesive, resorcinol resin adhesive, or modified adhesives thereof.

In addition, during the manufacturing process, after one or more steps of the step of obtaining the bamboo tube materials 20, the step of forming the bamboo strips 21, the step of forming the bamboo chips 22 with the square section, or the step of forming the plate units 23, the method further includes a step of performing a process of maintaining the high moisture content of the raw bamboo or performing the high moisture content process, which is a so-called wet method. For the wet method, in each step during the manufacturing process, for example, the process of maintaining the high moisture content of the raw bamboo is performed on the bamboo tube materials 20, the bamboo strips 21, the bamboo chips 22, or the plate units 23, or the high moisture content process is performed on them by placing them in a vapor room, a boiling tank, or soaking water, such that the bamboo fibers absorb the water, and the absolute dry moisture content is increased to be larger than 25%, thereby softening the bamboo fiber, reducing the inner stress of the bamboo. Therefore, the bamboo decorative sheets 26 with a thickness between 0.1 mm and 2.2 mm are obtained by the cutting tool 253 of the slicer and other devices.

When the wet method is used, the adhesive used in the gluing step is a polyurethane adhesive or the water-proof polyvinyl acetate adhesive and so on.

Further, in the bamboo decorative sheet 26 with a surface having lattice 261 grain formed by using the dry method or the wet method, a width grain of the lattice 261 is a width edge when forming the bamboo strip 21, and a length grain of the lattice 261 is formed by an included angle between the beveling surface 241 of laterally bevel cutting (not necessary from a diagonal line) the composite bamboo board and an original bottom surface of the composite bamboo board 25 (referring to FIG. 2A), and the preferred angle is between 5° and 70°. The larger the angle α is, the shorter the length of the lattice is, and on the contrary, the smaller the angle α is, the longer the length of the lattice is.

During the manufacturing process by using the dry method or the wet method, after the step of slicing the composite bamboo board 25 into the plurality of film-like bamboo decorative sheets 26, the method further includes a step of jointing the film-like bamboo decorative sheets 26 and 26a to form a bamboo decorative sheet with a larger area and with unified diagonal or staggered diagonal grain (referring to FIGS. 5A, 5B, 5C, and 5D).

In addition, the bamboo decorative sheets 26 and 26a manufactured by using the present invention have the lattice grain or the diagonal grain 263 being special and formed during the manufacturing process, so that the bamboo decorative sheets 26 and 26a can be adhered to cotton paper, non-woven cloth, clamp plate, calcium silicate, plastic plate, metal plate, and various base materials to serve as the surface decorations, thereby improving the additive value of the product.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention has developed the invariable straight strip-like decorative grain in the prior art into the lattice grain or diagonal grain, and the size of the lattice grain or diagonal grain can also be adjusted, such that the bamboo decorative sheet with a variety of grain can be produced and various requirements of the customers can be achieved.

What is claimed is:

1. A method for manufacturing a bamboo decorative sheet, applicable to a large volume bamboo board formed by gluing and stacking bamboo chips made of bamboo tube materials, the method comprising:
providing the large volume bamboo board;
bevel cutting the large volume bamboo board to form an upper part and a lower part, reversing the upper part and the lower part, overlapping and gluing the two parts to a composite bamboo board; and
slicing the composite bamboo board into a plurality of film-like bamboo decorative sheets, so that the bamboo decorative sheet with a surface having a decorative grain is formed.

2. The method for manufacturing a bamboo decorative sheet according to claim 1, wherein slicing surfaces in the step of slicing the composite bamboo board are parallel to a plane of the composite bamboo board, and the decorative grain on the surface of the bamboo decorative sheet is a lattice grain.

3. The method for manufacturing a bamboo decorative sheet according to claim 1, wherein slicing surfaces in the step of slicing the composite bamboo board are parallel to a lateral side of the composite bamboo board, and the decorative grain on the surface of the bamboo decorative sheet is a diagonal grain.

4. The method for manufacturing a bamboo decorative sheet according to claim 1, wherein after the step of slicing the composite bamboo board into the plurality of film-like bamboo decorative sheets, the method further comprises jointing the film-like bamboo decorative sheets to form the bamboo decorative sheet with a larger area.

5. The method for manufacturing a bamboo decorative sheet according to claim 1, wherein an absolute dry moisture content of the material of the large volume bamboo board is smaller than 20%, the bamboo board is sliced into the bamboo decorative sheets in parallel by sawing, a thickness of the sawed bamboo decorative sheet is between 1.5 mm and 5.0 mm, and a glue used in the gluing step is a water-proof glue comprising urea adhesive, melamine adhesive, phenol adhesive, polyvinyl acetate adhesive, resorcinol resin adhesive, or modified adhesives thereof.

6. A bamboo decorative sheet manufactured by using the method for manufacturing a bamboo decorative sheet according to claim 5, wherein the bamboo decorative sheet has lattice grain or diagonal grain.

7. The method for manufacturing a bamboo decorative sheet according to claim 1, further comprising performing a process of maintaining a high moisture content of the raw bamboo material or performing the high moisture content process on the bamboo tube materials, the bamboo chips, and the large volume bamboo boards, such that an absolute dry moisture content is larger than 25%, and the bamboo board is sliced into the bamboo decorative sheets, a thickness of the sliced bamboo decorative sheet is between 0.1 mm and 2.0 mm, and an adhesive used in the gluing step is an polyurethane adhesive or an water-proof polyvinyl acetate adhesive.

8. A bamboo decorative sheet manufactured by using the method for manufacturing a bamboo decorative sheet according to claim 7, wherein the bamboo decorative sheet has lattice grain or diagonal grain.
